(19) United States
(12) Patent Application Publication
(10) Pub. No.: US 2009/0085944 A1
(43) Pub. Date: Apr. 2, 2009

(54) PRINTER AND METHOD OF COMBINING INKJET PRINTING WITH THERMAL PRINTING

(76) Inventors: Mark E. Keeton, Kettering, OH (US); Timothy W. Rawlings, Waynesville, OH (US); Yaoping Tan, Lebanon, OH (US); Michael J. VanDemark, Springboro, OH (US)

Correspondence Address: PAUL W. MARTIN, NCR CORPORATION, LAW DEPT., 1700 S. PATTERSON BLVD., DAYTON, OH, 45479-0001, US

(21) Appl. No.: 12/332,469

(22) Filed: Dec. 11, 2008

Related U.S. Application Data
(63) Continuation of application No. 11/897,659, filed on Aug. 31, 2007.

(51) Int. Cl. B41J 29/38; B41J 35/16

(52) U.S. Cl. 347/9; 347/172

(57) ABSTRACT

A printer and method of combining inkjet printing with thermal printing which optimizes use of both. The printer includes a thermal print head, an inkjet print head, and control circuitry for activating the thermal print head to print in a first area of a print medium and for activating the inkjet print head to print in a second area of the print medium.

### CROSS-REFERENCE TO RELATED APPLICATION

The present application claims priority to application Ser. No. 11/897,659, filed Aug. 31, 2007, with common inventor Michael J. VanDemark, entitled, “DIRECT THERMAL AND INKJET DUAL-SIDED PRINTING”.

### BACKGROUND

Full color inkjet printing on receipts, coupons, and other documents intended for customers is typically of low quality. For example, low quality printing of barcodes on coupons makes reading these barcodes difficult.

Direct thermal printing is of higher quality, though direct thermal printing can produce only a limited number of colors.

It would be advantageous to provide a method of combining inkjet printing with thermal printing.

### SUMMARY

A printer and method of combining inkjet printing with thermal printing is provided.

The printer includes a thermal print head, an inkjet print head, and control circuitry for activating the thermal print head to print in a first area of a print medium and for activating the inkjet print head to print in a second area of the print medium.

### DESCRIPTION OF THE DRAWINGS

FIG. 1 shows a schematic of an example printing system.

### DETAILED DESCRIPTION

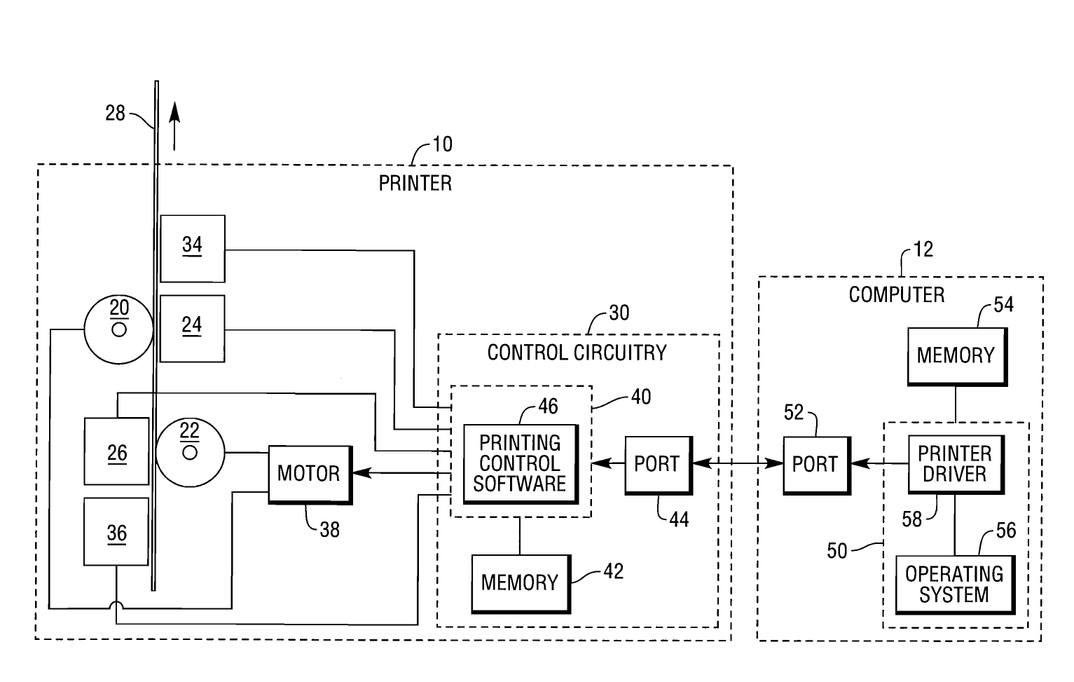

With reference to FIG. 1, example printer 10 combines direct thermal printing with inkjet printing. The illustrated printer 10 is useable for printing on two sides of print medium 28. However, printers which print only on one side of print medium 28 are also envisioned for use with the present invention.

Example printer 10 includes rotating platens 20 and 22 on opposite sides of print medium 28. Motor 38 rotates platens 20 and 22, for example, through gears affixed to platens 20 and 22, to feed print medium 28. An additional motor may be used to separately drive platen 20.

Example printer 10 further includes opposing thermal print heads 24 and 26 and opposing inkjet print heads 34 and 36 on opposite sides of print medium 28.

Printing of print medium 28 may occur in a single pass at, for example, completion of a transaction such as when a receipt or other document is issued. Alternatively, printing may occur in a two or more pass process where, for example, print medium 28 is imaged by one or both thermal print heads 24 and 26 when moving in a first direction, and then retracted for further imaging by one or both thermal print heads 24 and 26 with print medium 28 moving in either the first or a second, retract direction. Once printing is completed, print medium 28 may, depending on its format (for example, roll, fan fold, individual sheets, and the like), be manually or automatically cut or severed to provide an individual receipt, ticket, or other document.

Print medium 28 includes thermal paper, such a thermal paper having a cellulosic or polymer substrate sheet and heat sensitive dyes. Printing on opposite sides of print medium 28 can be facilitated by including a substrate sheet that is sufficiently thermally resistant to inhibit thermal printing on one side of print medium 28 from affecting coloration on the opposite side of print medium 28. To facilitate inkjet printing, print medium 28 is inkjet receptive.

Print medium 28 may be supplied in the form of a paper roll, fan-fold stack, individual sheet and the like, upon which printing such as graphics or text, or both, may be printed on one or both sides of print medium 28, to provide, for example, a voucher, coupon, receipt, ticket or other article or document.

Example printer 10 further includes control circuitry 30, which controls printing, including power delivered to thermal print heads 24 and 26, speed and direction of motor 38, and ink delivery by inkjet print heads 34 and 36.

In addition to specialized circuitry, such as power control circuitry, control circuitry 30 may include a processor or CPU 40, a memory 42, and a communications port 44 for communicating with one or more host or auxiliary computers 12 such as a POS terminal, travel kiosk computer, or other self-service or assisted-service terminal for input of data to, and output of data from, printer 10.

Processor 40 executes printer control software 46, which receives pre-formatted print data from computer 12 and controls printing on print medium 28 based upon the data.

Communications port 44 may support communications between printer 10 and computer 12 in the form of RS-232 serial, parallel, universal serial bus, Ethernet and/or wireless communications (for example, 802.11, 802.15, and IR), among others. Communications may be unidirectional or bi-directional.

Computer 12 includes a processor or CPU 50, memory 52, and communications port 54. Processor 50 executes an operating system 56 and a printer driver 58. An example operating system 56 may include a windowing operating system, such as one provided by Microsoft Corporation.

Computer 12 may include a host POS terminal, kiosk, or other self-service or assisted-service terminal communicating with printer 10. Supplemental data for printing, such as product and or discount coupon information, directions, road maps, way-finder data, or corporate logos among other types of data can also be supplied by, for example, a network server providing data directly to printer 10, or indirectly through the host POS terminal, kiosk, or other self-service or assisted-service terminal. The supplemental data for printing may vary depending upon the goods or services sold or provided.

Printer driver 58 converts information to be printed into a format and/or language that printer 10 understands. For example, printer driver 58 may convert the information into raster graphics format. Printer driver 58 may also configure printer 10 based upon selections available to an operator through a graphic user interface (GUI) associated with printer driver 58.

Printer driver 58 may be separate from or part of operating system 56 or an application program that also works with operating system 56. An example printer driver 58 may be supplied with printer 10 by a manufacturer of printer 10.

Printer 10 and computer 12 may be separate from each other or combined in a single enclosure, such as a kiosk enclosure.

Computer 12 may additionally include or be connected to peripherals supportive of its purpose. For example, if computer 12 is part of a travel kiosk, computer 12 may be coupled to a barcode reader, passport reader, and card reader. As another example, if computer 12 is part of a self-service or assisted-service checkout station, computer 12 may be coupled to a barcode reader, produce scale, card reader, cash acceptor and/or dispenser or cash drawer, and personal identification number (PIN) keypad.

In more detail, printer control software 46 identifies one or more colors in raster graphics information received from printer driver 58 and controls one or both of thermal print heads 24 and 26 to print in locations on media 28 corresponding to locations of the colors identified in the raster graphics information. Printer control software 46 identifies other colors in the raster graphics information and controls one or both of inkjet print heads 34 and 36 to print in locations on media 28 corresponding to locations of the other colors identified in the raster graphics information.

Printer control software 46 may apply thermal printing in the same or different areas as inkjet printing. Aggregating dots from thermal printing and dots from inkjet printing in the same area conserves ink. Printer control software 46 may apply thermal printing in areas where inkjet printing would otherwise quickly exhaust ink, such as areas requiring high contrast or bulky prints.

Printer control software 46 may cause thermal printing and inkjet printing to occur in any order; however, if thermal printing follows inkjet printing, printer control software 46 may delay thermal printing for a predetermined time period sufficient to allow ink to dry to avoid damaging thermal print heads 24 and 26. If media 28 is affected by the water in the ink, printer control software 46 may delay thermal printing for a predetermined time period sufficient to allow this water to evaporate. Applying inkjet printing after thermal printing results in faster, higher quality, printing without risking damage to thermal print heads 24 and 26.

In an example printing, printer control software 46 may direct one or both of thermal print heads 24 and 26 to produce the color black and direct one or both of inkjet print heads 34 and 36 to produce other colors. Black dots from thermal printing may form a barcode. With or without black dots from thermal printing, inkjet printing may form a color image.

Printer control software 46 may produce the dots of the other colors by combining inks of a plurality of base colors. For example, printer control software 46 may produce the dots of the other colors by combining inks of primary colors cyan, magenta, and yellow. In order to save black ink, printer control software 46 may direct one or both of thermal print heads 24 and 26 to produce black dots as part of the color image.

In a modification of the above example, printer control software 46 may direct one or both of thermal print heads 24 and 26 to produce a color other than black. Today, media 28 may include dyes that result in other colors than black, such as various shades of red, green, and blue.

In another modification of the above example, printer control software 46 may direct one or both of thermal print heads 24 and 26 to produce two or more colors. Media 28 may include a plurality of dyes that activate at different temperatures. For example, thermal printing may produce black and red and inkjet printing may produce yellow, cyan, and combinations thereof. In order to save red and black ink, printer control software 46 may direct one or both of thermal print heads 24 and 26 to produce black and red dots as part of the color image.

Although particular reference has been made to certain embodiments, variations and modifications are also envisioned within the spirit and scope of the following claims.

What is claimed is:

1. A printer comprising:
a thermal print head;
an inkjet print head; and
control circuitry for activating the thermal print head to print in a first area of a print medium and for activating the inkjet print head to print in a second area of the print medium.

2. The printer of claim 1, wherein the first and second areas are separate.

3. The printer of claim 1, wherein the first and second areas overlap.

4. The printer of claim 1, wherein the thermal print head and the inkjet print head print different colors.

5. The printer of claim 1, wherein the inkjet print head prints at least one different color than the thermal print head.

6. The printer of claim 1, wherein the thermal print head prints a first image in black and the inkjet print head prints a second image in a plurality of colors.

7. The printer of claim 1, wherein the control circuitry activates the thermal print head to print a color instead of the inkjet printer to conserve ink.

8. The printer of claim 1, wherein the control circuitry activates the inkjet print head to print a color that the thermal print head cannot print.

9. The printer of claim 1, wherein the control circuitry activates the thermal print head to complete thermal printing then activates the inkjet print head to complete inkjet printing.

10. The printer of claim 9, wherein the control circuitry completes the thermal printing and the inkjet printing in a single pass of the medium.

11. The printer of claim 9, wherein the control circuitry completes the thermal printing in one pass of the medium and then completes the inkjet printing in a second pass of the medium.

12. The printer of claim 1, wherein the control circuitry activates the inkjet print head to complete inkjet printing, waits a predetermined amount of time, then activates the thermal print head to complete thermal printing.

13. The printer of claim 1, further comprising another thermal print head for printing on a second side of the print medium opposite to a first side on which the one thermal print head prints, wherein the control circuitry activates the other thermal print head for printing on the second side.

14. The printer of claim 1, further comprising another inkjet print head for printing on a second side of the print medium opposite to a first side on which the one inkjet print head prints, wherein the control circuitry activates the other inkjet print head for printing on the second side.

15. A printing method comprising:
(a) activating a thermal print head to print in a first area of a print medium by a printing control circuitry; and
(b) activating an inkjet print head to print in a second area of the print medium by the printing control circuitry.

16. The method of claim 15, wherein the first and second areas are separate.

17. The method of claim 15, wherein the first and second areas overlap.

18. The method of claim 15, wherein step (a) comprises printing first colors and step (b) comprises printing second colors different than at least one of the first colors.

19. The method of claim 15, wherein step (a) comprises printing a first image in black and step (b) comprises printing a second image in a plurality of colors.

20. The method of claim 15, further comprising:
(c) activating another thermal print head to print in a third area on a second side of the print medium opposite to a first side on which the one thermal print head and the one inkjet print head print by the printing control circuitry; and
(d) activating another inkjet print head to print in a fourth area on the second side of the print medium by the printing control circuitry.
